(19) United States
(12) Patent Application Publication
(10) Pub. No.: US 2002/0014142 A1
(43) Pub. Date: Feb. 7, 2002

(54) Air actuated finger pull back chuck

(76) Inventors: Andrew J. Ward, Fowlerville, MI (US); Robert Bruce Emerson, Gregory, MI (US)

Correspondence Address: Barbara M. Burns, 1756 Plymouth Road #276, Ann Arbor, MI, 48105, US

(21) Appl. No.: 09/912,202

(22) Filed: Jul. 24, 2001

Related U.S. Application Data
(60) Provisional application No. 60/221,432, filed on Jul. 28, 2000.

(51) Int. Cl. B23B 31/00; B23B 31/30

(52) U.S. Cl. 82/165; 82/168

(57) ABSTRACT

An air actuated finger pull back chuck device having a locating portion and a clamping portion. Locator slides and locator cams are air actuated to position the workpiece. The workpiece is located to the device with locator slides and air actuated clamp arms operate clamp fingers to pull back and hold a workpiece to the chuck device for the operation. The locator cams have a single connector to the locator actuator plate and the locator cams can be quickly reversed for locating on an inside diameter or an outside diameter. Various fingers can be attached to the clamp arm to fit various workpiece sizes. The quick change over times for different sized and shaped workpieces are facilitated by the simplicity of the invention.

This application is based on Provisional Patent Application Serial No. 60/221,432 filed Jul. 28, 2000.

### BACKGROUND OF THE INVENTION

The field of the invention pertains to chucking devices or chucks for holding a workpiece or workpieces for rotational machining thereof, and in particular, to an air actuated finger pull back chuck. For machining a part like a vehicle wheel by turning or boring operations, the part must be held securely. Turning operations can be problematic in that the part is rotated and the cutting tool remains fixed or vice versa. The larger the part the greater the problem can be due to the mass of the part. Moreover, a device that can be quickly and easily converted to a different size part is highly desirable.

Older chucks could only be used for a few sizes of workpieces. If the workpiece was larger than that size, then the chuck had to be removed from the machine and another chuck positioned to the machine for the larger size workpiece. The time required for the changeover from one chuck to another chuck could take thirty minutes or longer. Consequently, the changeover time reduced productive time on the machine.

Even more desirable is a device that can adjust for multiple part sizes with simple adjustments. Thus is needed a device to securely hold a rotating part in a machine during the machining operation. Also is needed a device that can securely hold the part and yet be quickly and easily configured for different size and shaped parts or workpieces. Moreover, a device is needed to securely hold rotating parts and last more than two to three months before requiring to be rebuilt.

Therefore, a more effective and convenient to use device for chucking a part for machining is an advantageous goal. Such more effective device and method for use of the device are disclosed below.

### SUMMARY OF THE INVENTION

The invention comprises a device for chucking a workpiece like a wheel, for use during a rotating machining operation such as turning or boring. The chucking device is mounted to a machining device such as a turning, boring or other machine in a conventional manner by mounting the device onto the spindle of the turning, boring or other machine.

The workpiece is located to the device and then the workpiece is clamped securely on the inside diameter (I.D.) or on the outside diameter (O.D.). The device for chucking of the invention allows higher revolutions per minute (R.P.M.) of the workpiece and better locking of the workpiece in the range of about 40 to about 120 pounds per square inch (PSI) air pressure form a conventional air source such as a compressor. Better surface finish is often observed at higher rotational speeds.

The chucking device or fixture for turning or boring operations holds a workpiece. The workpiece is machined by clamping on an outside diameter O.D. of a wheel flange and turning across the O.D. of the wheel “rim contour”, brake clearance mounting surface and bore. The chucking device of the invention can hold 13 inch diameter parts and with simple changeovers, can hold up to 20 inch diameter parts. Further operations clamp on the inboard flange and machine the lowest part of the rim contour (or outboard edge), safety hump, bead seat, flange and cross face of a wheel. Prior fixtures used a draw bar for this type of machining.

The device for chucking is comprised from a housing, a spindle mount, an actuator plate, a tooling plate, a locator actuator/plate, a locator cam, a locator slide, a clamp arm with clamp fingers and other necessary parts.

The locator plate is actuated by routing air pressure from an air source through a check valve to a piston to operate the locator/actuator plate. The locator plate employs locator cams to operate locator slides that have locators mounted on the locator slides. The locators are either for locating on the outside diameter of a workpiece or for locating on the inside diameter of a workpiece. The locator slides move the locators into contact with the workpiece and center the workpiece to the chucking device. Counterweights engaged through a rocker pin with the locator slides resist the centrifigal force exerted by the rotating workpiece against the locator. The locator slides and locators can be easily changed for a variety of workpiece sizes and operations as described below.

Air pressure is used to locate and lock the workpiece in the chucking device. A check valve controls air flow to a piston to actuate the locator plate and the actuator plate and operate the air actuated parts, the clamp arms and the locator slides. Thus, air pressure operates the slide and the clamp arm to the desired position. When the air pressure is released the slide moves in the opposite or release direction. Similarly, when the air pressure is released the clamp arm releases and the clamp opens.

The locator cams are reversible so as to be used for clamping on an inside diameter and also on an outside diameter of a workpiece. When changing over for an operation that clamps the workpiece on an inside diameter, the counterweight and the rocker pin can be removed from the slide assembly. Different slide locators are used for locating on the inside diameter as compared with the slide locators that are used for locating on the outside diameter.

Each locator cam has a diagonally disposed cam path which is an elongated slot. The locator cams are mounted on the locator plate. When the locator plate is moved vertically by air actuation, the locator cam moves on the cam pin along the cam path. Hence, the locator slide is moved towards the center of the device as the cam pin is at the inside extent of travel in the cam path. The locator slide moves away from the center of the device when the locator plate operates the cam pin in the locator cam to move the cam to the outside extent of travel. When the locator cam is reversed, the cam pin moves in the opposite direction. Thus can locating be achieved on an inside diameter of a workpiece or on an outside diameter of a workpiece.

The air actuated clamp fingers are operated via a cam slot in the clamp arm connected with the actuator plate. The cam slot in the clamp actuator arm has an elongated dog leg slot therein. The actuator plate is moved vertically by air pressure on a piston in the device. The clamp fingers can take a variety of configurations depending upon the workpiece configuration and the operation being performed. A workpiece is placed on a rest pad, the slide locators move the workpiece into position and the air actuated clamp fingers lock the workpiece against the rest pad for a machining operation.

As air pressure is routed through the check valve, the air pressure moves the actuator plate so that the arm pivots at the pivot point. The actuator finger on the actuator arm clamps against the workpiece and holds the workpiece against the rest pad. When air pressure is released, the actuator arm returns to its open position at the other end of the cam path and opens and releases the actuator finger on the actuator arm from the workpiece.

The method of use of the device, the air actuated finger pull back chuck comprises the following steps:

placing a workpiece to the chuck;

operating means for locating the workpiece to the chuck; and

operating means for clamping the workpiece to the chuck.

The method also can employ the steps of

operating means for clamping by air pressure; and

actuating the means for clamping by operating a clamp arm to actuate the clamp finger.

### BRIEF DESCRIPTION OF THE DRAWINGS

FIG. 1 illustrates a perspective view of the chucking device;

FIG. 2 illustrates a top view of the chucking device with a replaceable ring;

FIG. 2A illustrates a bottom view of the chucking device;

FIG. 3 illustrates a sectional view through the chucking device taken along section line A-A in FIG. 2, showing the clamp arm in the clamped or closed position;

FIG. 3A illustrates a partial sectional showing the clamp arm in the retracted or open position;

FIG. 3B illustrates a partial sectional view through the chucking device with the locator slide at the outside point of travel;

FIG. 3C illustrates a partial sectional view through the chucking device with the locator slide at the inside point of travel;

FIG. 4 illustrates a perspective view of the clamp arm showing the elongated dog leg cam slot;

FIGS. 5A, 5B, 5C and 5D illustrate clamp finger options for the clamp arm;

FIG. 6 illustrates an exploded view of the locator actuator, actuator plate with clamp arms, the housing and the spindle mount;

FIG. 7 illustrates the tooling plate;

FIG. 8 illustrates a locator cam;

FIG. 9 illustrates a locator slide;

FIG. 10 illustrates a rocker pin for the slide locator;

FIG. 11 illustrates a counter weight;

FIG. 12 illustrates a plate counter weight; and

FIG. 13 illustrates an O.D. locator.

### DESCRIPTION OF THE PREFERRED EMBODIMENTS

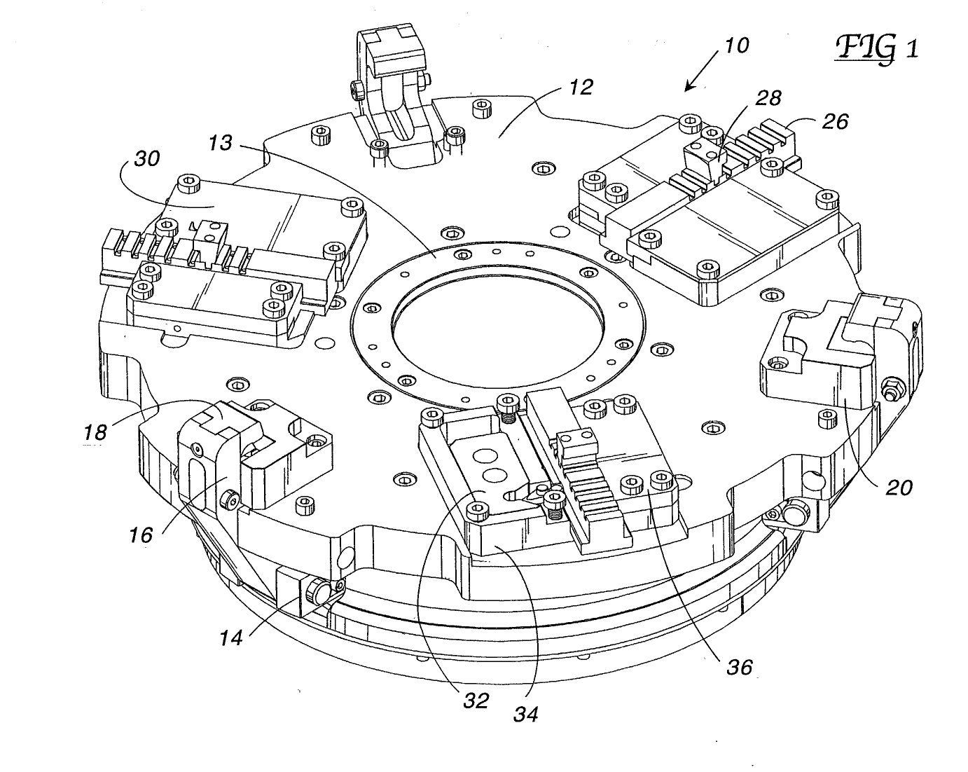

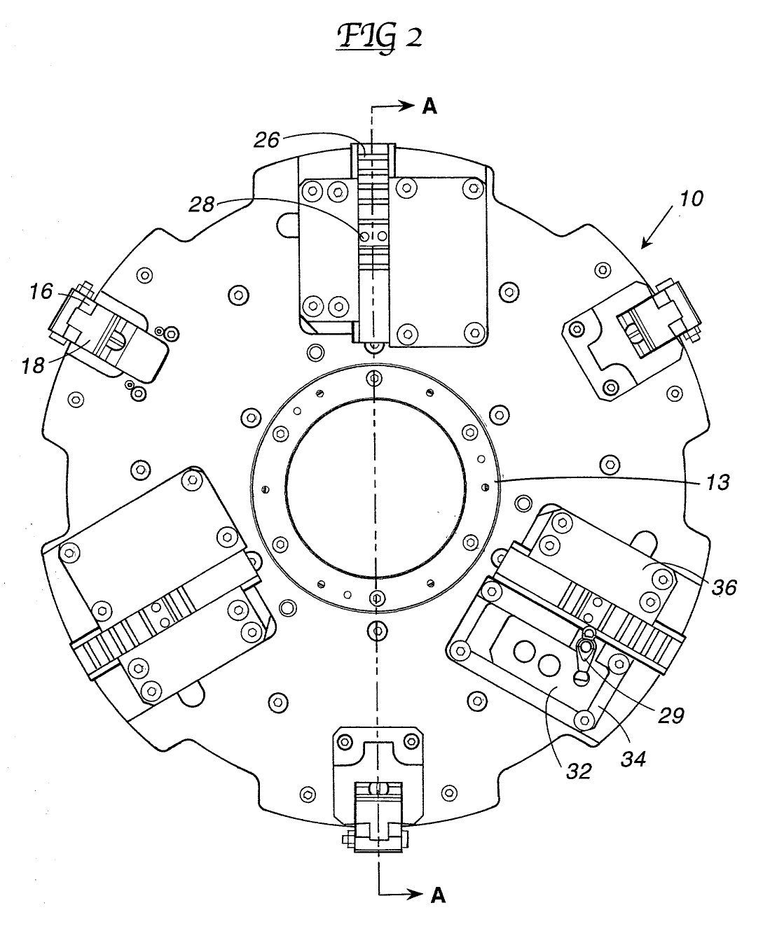

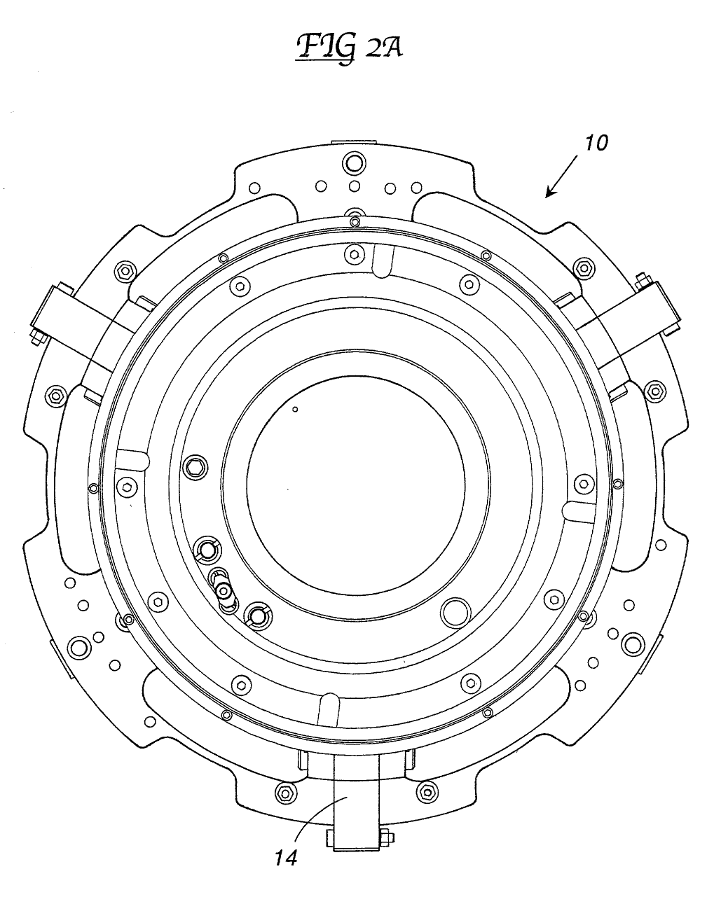

In FIGS. 1 and 2, chucking device 10 is illustrated as comprising tooling plate 12, actuator plate 14, clamp arm 16, clamp finger 18 and rest pad 20. Tooling plate 12 has replaceable ring 13 at the center of top plate 12 so that ring 13 can be replaced for wear reasons.

One locator 28/locator slide 26 and one clamp arm 16 will be described, but it is to be understood that more than one locator/locator slide and more than one clamp arm may be necessary to the safe operation of the invention.

Locator slide 26 and clamp arm 16 are shown in FIG. 2. Air pressure is the motive force used to actuate both clamp arm 16 and locator slide 26 as will be described in greater detail. Air pressure is introduced to the device through a check valve and the air pressure moves a piston inside the device to move the actuator plate and the locator actuator plate to operate the actuator arms and the locator slides, respectively. A bottom view of chucking device 10 is depicted in FIG. 2A.

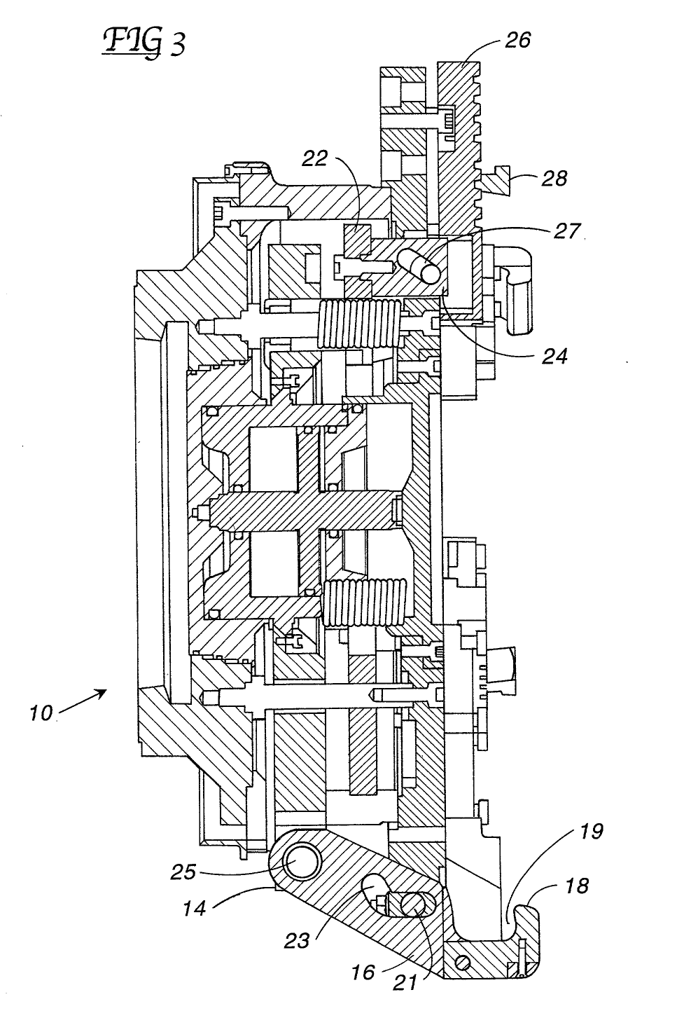

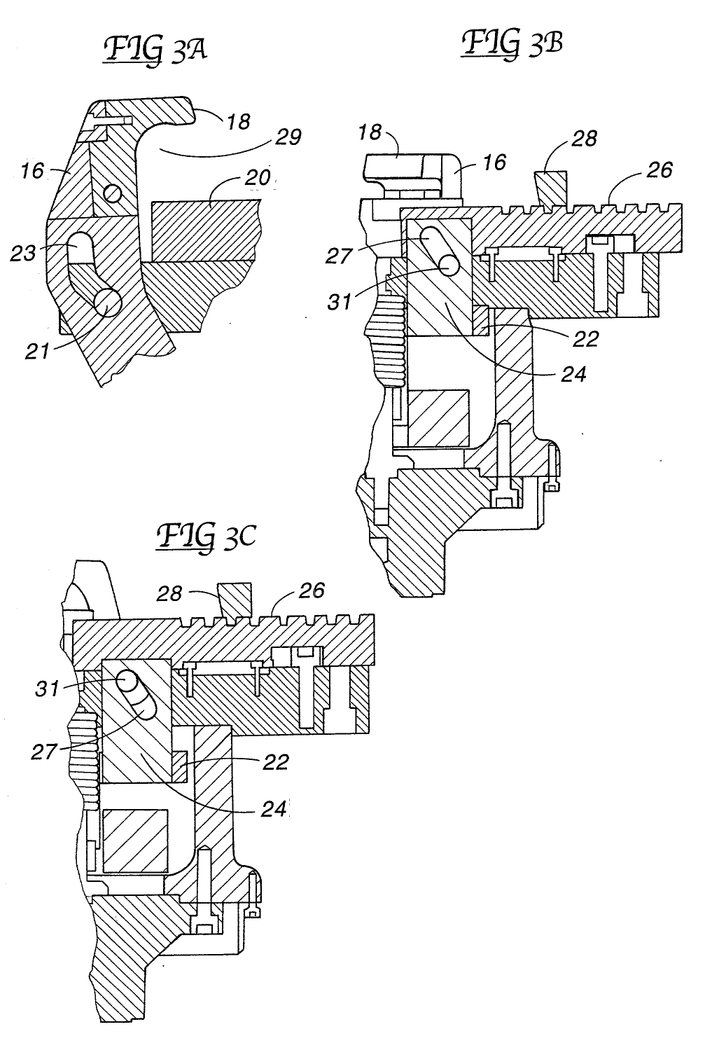

Locator actuator plate 22 (FIG. 3) operates locator cam 24 and locator slide 26 and hence operates locator 28 mounted on locator slide 26. Referring back to FIGS. 1 and 2, counter weight 32 is connected with locator slide 26 by rocker pin 29. Counter weight 32 is contained within plate counter weight 34. Cover plate 30 fits to plate counter weight 34 and cover plate 30 covers the locator counter weight 32 and provides an edge over the long side of locator slide 26 for providing control for locator slide 26. Retainer clamp 36 mounted on the other long side of locator slide 26 provides a parallel control edge for locator slide 26.

In FIG. 3, device 10 is thereshown in sectional view with clamp finger 18 in a closed position 19 (or pull back position, pulling workpiece, not shown) into a locked position) with pin 21 at the extent of travel in dog leg cam slot 23 of clamp arm 16. Clamp arm 16 pivots about bore 25 at the end of clamp arm 16 away from the clamp finger 18 part of clamp arm 16. It is to be understood that as actuator plate 14 moves, dog leg cam slot 23 of the clamp arm 16 moves around pin 21 to the opposite end of the cam slot 23 the clamp arm will be moved to an open position 29 (shown in FIG. 3A).

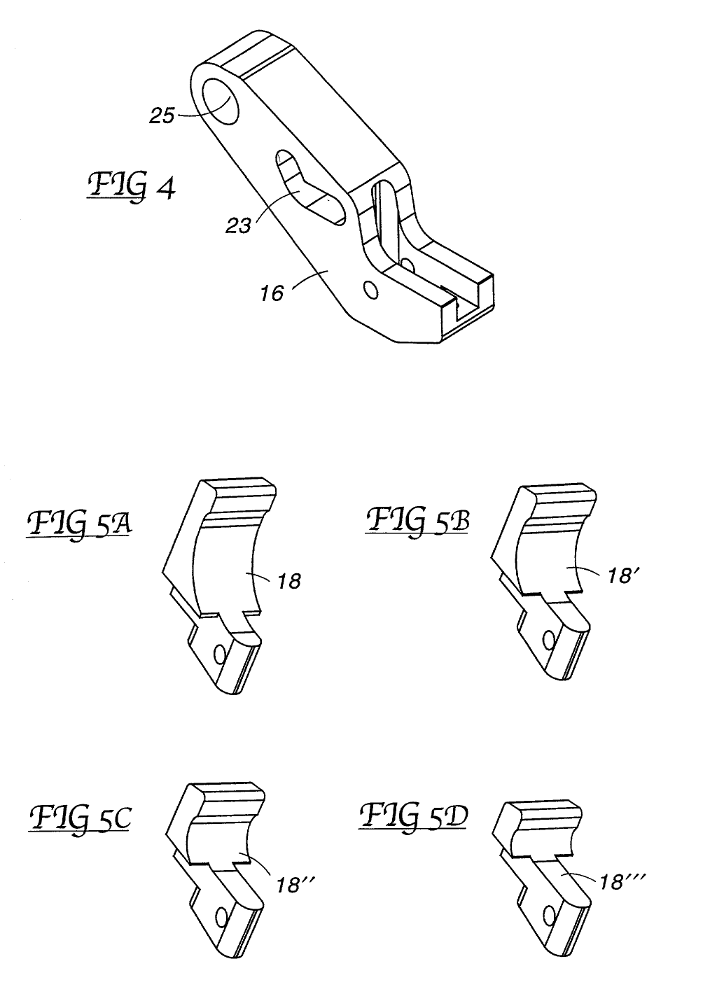

Clamp arm 16 is better shown in FIG. 4. It is to be understood that for larger diameter workpieces, clamp arm 16 can have different configurations to fit the larger workpiece. Various clamp fingers 18, 18′, 18″ and 18′″ are fittable to clamp arm 16 and the various clamp fingers are used for a variety of workpieces. Clamp fingers 18, 18′, 18″, 18′″ are better shown in FIGS. 5A-5D.

Now turning to FIGS. 3B and 3C thereshown is locator slide 26. Locator actuator plate 22 is moved by air actuation and as locator actuator plate 22 moves vertically, connected locator slide 26 is moved horizontally. Locator slide 26 is at the outside extent of travel with cam pin 31 at the lower point of cam slot 27 (FIG. 3B). When cam pin 31 is at the upper point of cam slot 25 the locator slide 26 is at the inside point of travel (FIG. 3C).

Locator cam 24 can be reversed easily by unscrewing a screw that holds locator cam 24 to locator plate and reversing locator cam 24. This reversal of locator cam 24 has the effect of operating locator slide 26 in the opposite direction. Locators on locator slide may need to be replaced for location on a different feature of a workpiece.

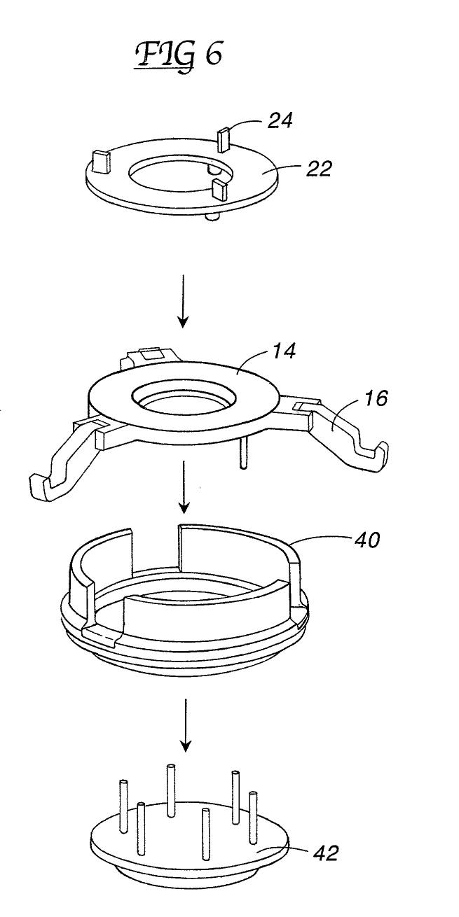

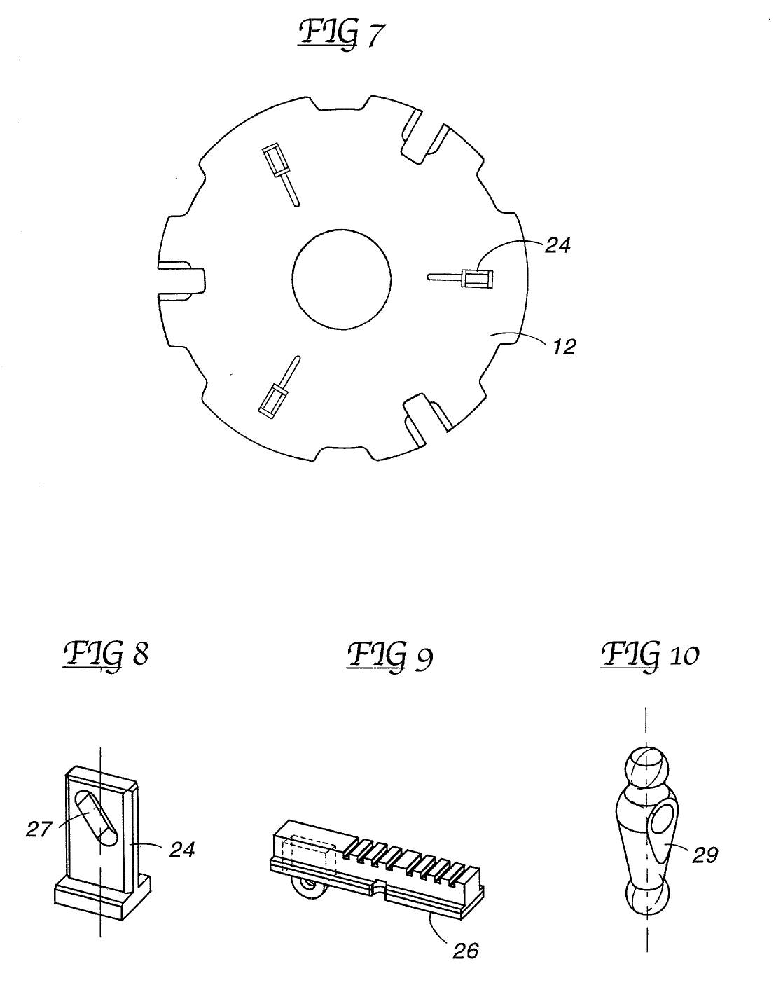

An exploded view of locator actuator plate 22, actuator plate 14, clamp arm 16, housing 40 and spindle mount 42 is shown in FIG. 6. Clamp arm 16 is shown in a loose position pivoted away from actuator plate 14. Tooling plate 12 is shown in FIG. 7 with locator cam 24 extending through tooling plate 12.

Locator cam 24 is better shown in FIG. 8 with a diagonal cam slot 27. Locator cam 24 employs a single bolt hole (depicted with a center line) for insertion means for connecting, such as a shoulder bolt or other connector to attach the locator cam 24 to the locator actuator plate 22. The shoulder bolt/connector (not shown) allows the locator cam to be loosened and rotated so the diagonal slot is reversed.

Locator slide 26 is better shown in FIG. 9 as having a slot into which locator cam 24 is fittable for moving locator slide 26. Rocker pin 29 that connects locator slide 26 with the counterweight is better shown in detail in FIG. 10.

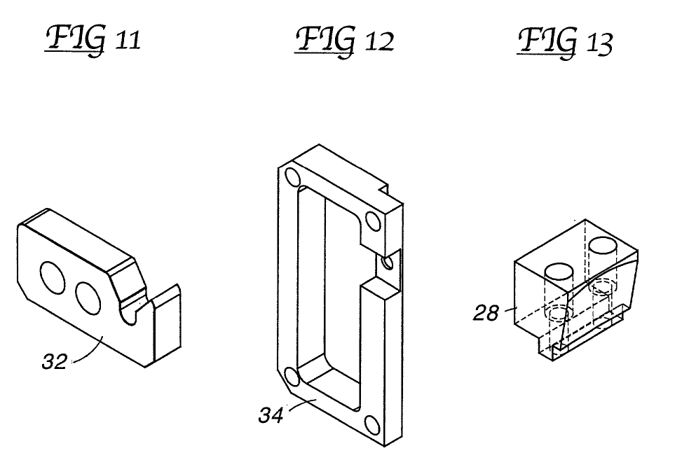

Counter weight 32 for locator slide 26 is better shown in FIG. 11 with plate 34 counter weight for containing counter weight being better shown in FIG. 12. Cover plate 30 is better shown in FIGS. 1 and 2. Retainer clamp 36 is better shown in FIG. 1. The O.D. locator 29 is better shown in FIG. 13. The rest pad 20 is better shown in FIG. 1.

It is to be understood that the chucking device as herein described could be employed for use with other machining operations and for other purposes beyond those for turning and boring for a wheel as described.

1. A device for chucking a rotatable workpiece for rotatable machining operations, the device comprising:
at least one finger segment, the at least one finger segment being air actuatable to lock a rotatable workpiece, and means for actuating the at least one finger segment.

2. The device according to claim 1 wherein the means for actuating the at least one finger segment comprises at least one clamp arm connected with the at least one finger segment.

3. A device for holding a workpiece for machining, the device comprising:
a fixture capable of being rotated at high speeds; and
a clamp arm for clamping a workpiece to the fixture, the clamp arm being air actuatable for clamping.

4. The device according to claim 1 wherein the means for actuating comprises 40-120 psi air pressure.

5. The device according to claim 1 further comprising means for locating a rotatable workpiece.

6. The device for chucking according to claim 1 further comprising means for locating.

7. The device for chucking according to claim 6 wherein the means for locating comprises at least one locator slide having a locator for locating on one of an inside diameter and an outside diameter of a workpiece.

8. A device for chucking according to claim 7 further comprising at least one locator cam.

9. A device for chucking according to claim 1 further comprising at least one replaceable wear ring on a top plate.

10. A method of use of an air actuated finger pull back chuck, the method comprising the following steps:
placing a workpiece to the chuck;
operating means for locating the workpiece to the chuck; and
operating means for clamping the workpiece to the chuck.

11. The method according to claim 10 further comprising the following steps:
operating means for clamping by air pressure; and
actuating the means for clamping by operating a clamp arm to actuate the clamp finger.

12. The device according to claim 1 wherein the air actuation comprises about 40 psi air pressure to about 120 psi air pressure.

13. The device according to claim 1 wherein the means for locking comprises an actuator arm having an elongated slot.

14. The device according to claim 13 wherein the elongated slot comprising a dog leg slot.

15. A device for chucking according to claim 7 further comprising at least one locator cam having a diagonal slot being engageable with the locator slide.

16. The device according to claim 8 wherein the at least one locator cam being reversible.

17. The device according to claim-16 wherein the locator cam having a threaded aperture and being attachable to the locator actuator with a means for attaching.

18. The device according to claim 17 wherein the means for attaching comprises a shoulder bolt.

19. The device according to claim 7 further comprising means for maintaining the locator slide in a location position comprising a counterweight and a rocker pin connecting the counter weight with the locator slide.

20. The device according to claim 1 wherein the device is rotatable at high revolutions per minute.
